(19) United States
(12) Patent Application Publication
(10) Pub. No.: US 2007/0279669 A1
(43) Pub. Date: Dec. 6, 2007

(54) Image forming apparatus and image forming method

(75) Inventor: Keiko Kanamori, Numazu-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: Kabushiki Kaisha Toshiba, Minato-ku (JP); Toshiba Tec Kabushiki Kaisha, Shinagawa-ku (JP)

(21) Appl. No.: 11/445,676

(22) Filed: Jun. 2, 2006

(51) Int. Cl. G06K 15/00; G05B 11/01

(52) U.S. Cl. 358/1.14; 700/23

(57) ABSTRACT

A controller in an MFP starts a warm up needed for a capability given with a high priority at a time of returning when the MFP comes in the normal startup state or in the return state from the power saving mode as the power supply button or the power saving mode button of the MFP is depressed. In a case where the user selects any one of capability selection buttons as a capability he wishes to use while the machine of the MFP is returning, the controller starts a warm up needed for the capability assigned to the selected capability selection button, and enables the selected capability when the warm up ends. Also, in a case where no capability selection button is selected, the controller enables the capability given with a high priority when the warm up for the capability given with a high priority ends.

### BACKGROUND OF THE INVENTION

1. Field of the Invention

The present invention relates to an image forming apparatus that forms an image as a multi function peripheral furnished with multiple capabilities, such as the facsimile capability, the scan capability, and the print capability, and to an image forming method.

2. Description of the Related Art

Conventionally, an MFP (Multi Function Peripheral) is furnished with the facsimile capability, the scan capability, and the print capability in addition to the copy capability. In such an MFP, even in a case where one is to use the scan capability or the facsimile transmission capability that only uses the scanner when the power supply is switched ON or the mode is returned from the saving mode, the capability is not enabled unless the apparatus is ready for printing.

In addition, manipulations to open the setting screen for machine settings and to view the logins in the past cannot be performed unless the apparatus is ready for printing.

Although the returning speed until the apparatus becomes ready for printing has been increasing every year, there is a problem that even when one uses the scan capability alone or when one merely makes a facsimile transmission, he has to wait for the apparatus to be ready for printing in order to bring back the documents that have been read.

### BRIEF SUMMARY OF THE INVENTION

The object of an aspect of the present invention is to provide an image forming apparatus as an MFP furnished with multiple capabilities that enables a capability selected when the power supply is switched ON or the mode is returned from the power saving mode upon completion of the setup for the capability, and an image forming method.

According to an aspect of the present invention, there is provided an image forming apparatus that is furnished with multiple capabilities and forms an image, including: instruction means for giving an instruction, for the apparatus having two states including a normal state in which at least a normal operation is performed and a power saving state in which power consumption is less than in the normal state, to return to the normal state from the power saving state; first control means for controlling a return operation needed for a pre-set capability given with a high priority when the power saving state is returned to the normal state according to the instruction from the instruction means; and second control means for controlling the capability to be performed when the return operation ends under control of the first control means.

According to another aspect of the present invention, there is provided an image forming method for forming an image for an apparatus furnished with multiple capabilities, comprising: under circumstances that the apparatus has two states including a normal state in which at least a normal operation is performed and a power saving state in which power consumption is less than in the normal state, providing an instruction to return to the normal state from the power saving state; controlling a return operation needed for a pre-set capability given with a high priority when the power saving state is returned to the normal state according to the instruction; and controlling the capability to be performed when the return operation ends under control.

Additional objects and advantages of an aspect of the invention will be set forth in the description which follows, and in part will be obvious from the description, or may be learned by practice of the invention. The objects and advantages of an aspect of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of an aspect of the invention.

FIG. 1 is a block diagram schematically showing the structure of an MFP according to an image forming apparatus of the present invention;

FIG. 2 is a view showing the configuration of a manipulation panel; and

FIG. 3 is a flowchart used to describe an operation when the power supply is switched ON or a returning operation from the power saving mode.

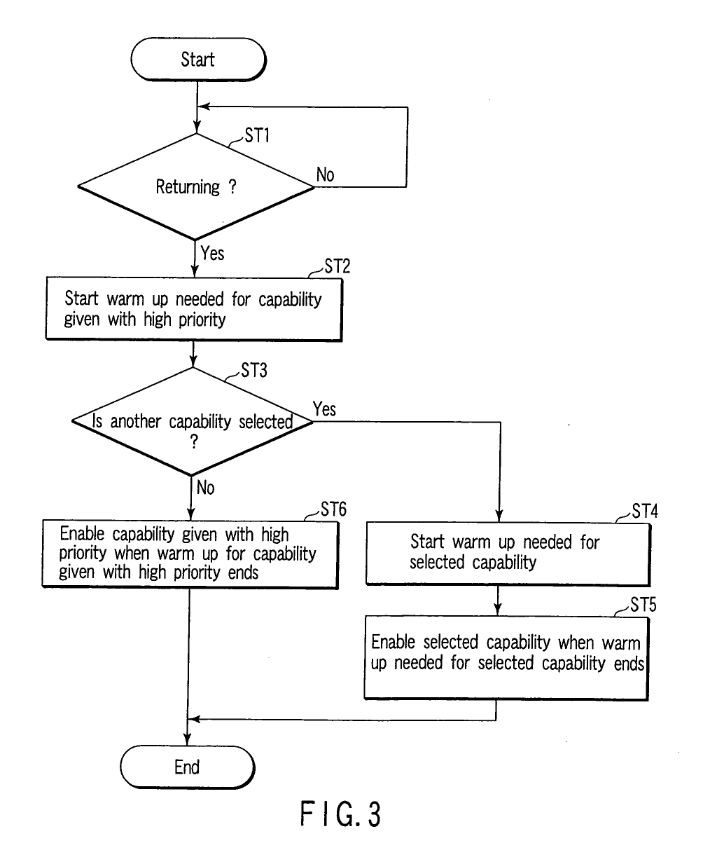

### DETAILED DESCRIPTION OF THE INVENTION

Hereinafter, one embodiment of the present invention will be described with reference to the drawings.

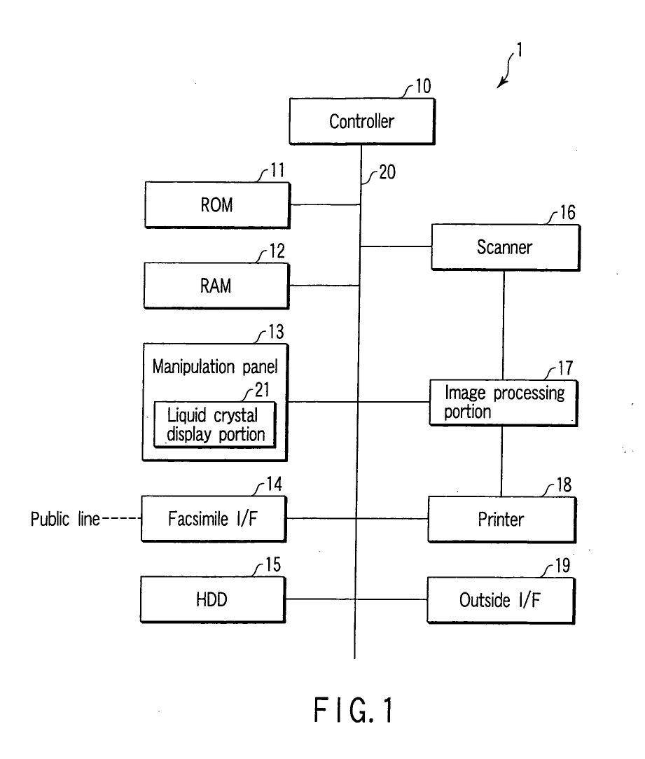

FIG. 1 is a view schematically showing the configuration of a multi function peripheral (hereinafter, abbreviated as MFP) according to an image forming apparatus of the present invention.

As is shown in FIG. 1, the MFP 1 includes a controller 10, a ROM 11, a RAM 12, a manipulation panel 13, a facsimile interface (I/F) 14, a hard disc drive (HDD) 15, a scanner 16, an image processing portion 17, a printer 18, an outside interface (I/F) 19, etc. Also, all the components are interconnected via a bus 20 having the controller 10 at the center.

A CPU is used for the controller 10. The controller 10 controls an overall operation of the MFP 1 and operates according to a program pre-installed in the ROM 11.

The RAM 12 stores facsimile data, document data, image data, etc. or various kinds of information.

The operation panel 13 includes a display comprising a liquid crystal display portion 21 equipped with a touch panel, and includes plural hard keys described below. On this manipulation panel 13, various manipulations are made for the MFP 1 with the use of plural hard keys and the liquid crystal display portion 21 equipped with the touch panel.

The facsimile interface (I/F) 14 is connected to a public line, through which facsimile transmission and reception are made with the use of the facsimile capability furnished to the MFP 1.

The HDD 15 stores facsimile data, document data, image data, etc. or various kinds of information.

The scanner 16 scans a document optically and changes the document into the form of image data.

The image processing portion 17 performs various kinds of processing on the image data.

The printer 18 prints facsimile data, document data, image data, etc. on a sheet of paper. The printer 18 may be of any type, such as an electrophotographic type and an ink-jet type; however, assume that the electrophotographic type is used in this embodiment.

The outside interface (I/F) 19 establishes a link to a personal computer, the LAN, the Internet, etc.

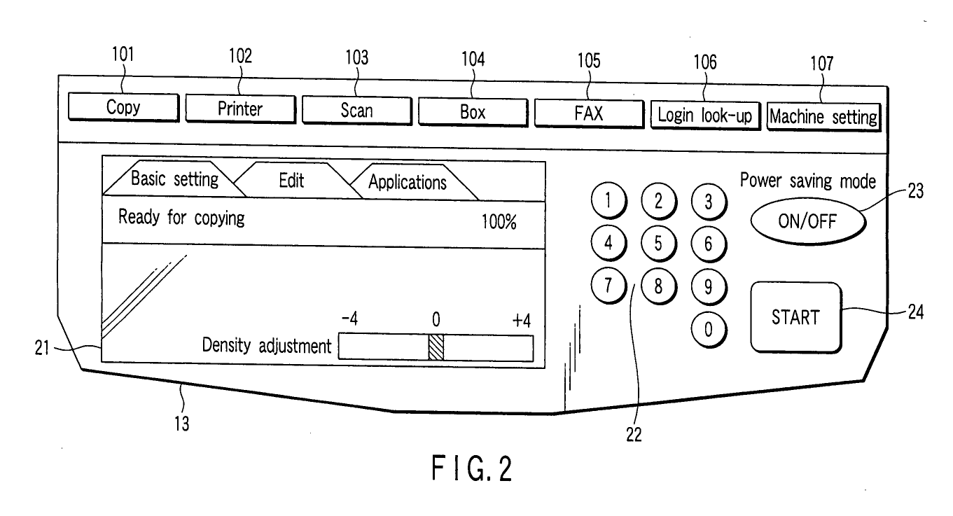

FIG. 2 is a view showing the configuration of an outward appearance of the manipulation panel 13.

The manipulation panel 13 is formed of the liquid crystal display portion 21 equipped with a touch panel and hard keys comprising ten keys 22, a power saving mode key 23, and a start key 24. Also, the manipulation panel 13 is provided with a copy capability selection button 101, a printer capability selection button 102, a scan capability selection button 103, a box capability selection button 104, a facsimile (FAX) capability selection button 105, a login look-up capability selection button 106, and a machine setting capability selection button 107, all of which are also hard keys.

The copy capability selection button 101 is a button to select the copy capability, and when this button is depressed, the controller 10 starts to control the copy capability by switching the display on the liquid crystal display portion 21 to that of the copy capability.

The printer capability selection button 102 is a button to select the printer capability, and when this button is depressed, the controller 10 starts to control the printer capability by switching the display on the liquid crystal display portion 21 to that of the printer capability.

The scan capability selection button 103 is a button to select the scan capability, and when this button is depressed, the controller 10 starts to control the scan capability by switching the display on the liquid crystal display portion 21 to that of the scan capability.

The box capability selection button 104 is a button to select the box capability, and when this button is depressed, the controller 10 starts to control the box capability by switching the display on the liquid crystal display portion 21 to that of the box capability.

The facsimile capability selection button 105 is a button to select the facsimile capability, and when this button is depressed, the controller 10 starts to control the facsimile capability by switching the display on the liquid crystal display portion 21 to that of the facsimile capability.

The login look-up capability selection button 106 is a button to select the login look-up capability, and when this button is depressed, the controller 10 starts to control the login look-up capability by switching the display on the liquid crystal display portion 21 to that of the login look-up capability.

The machine setting capability selection button 107 is a button to select the machine setting capability, and when this button is depressed, the controller 10 starts to control the machine setting capability by switching the display on the liquid crystal display portion 21 to that of the machine setting capability.

An operation when the power supply is switched ON or a returning operation from the power saving mode in the configuration as above will now be described.

Initially, when the power supply button (not shown) or the power saving mode key 23 of the MFP 1 is depressed and the MFP 1 comes in a normal startup state or in a returned state from the power saving mode (ST1), the controller 10 starts a warm up needed for the capability given with a high priority at the time of returning (ST2).

The capability given with a high priority at the time of returning can be changed, for example, by changing the setting on the display screen of the liquid crystal display portion 21 switched when the machine setting capability selection button 107 is depressed.

When the user selects any one of the seven capability selection buttons, the capability selection buttons 101 through 107, as the capability he wishes to use while the MFP 1 is in a machine returning operation (ST3), the controller 10 starts a warm up needed for the capability assigned to the selected capability selection button (ST4). The controller 10 then enables the selected capability when the warm up needed for the selected capability ends (ST5).

Also, when no capability selection button is selected in STEP ST3, the controller 10 enables the capability given with a high priority when the warm up for the capability given with a high priority ends (ST6).

For example, when the facsimile capability selection button 105 is selected, because the scanner 16 alone is used, a facsimile transmission operation is enabled as soon as the warm up for the scanner 16 is completed. In this instance, it is possible to set manipulations beforehand. That is, a document can be set or the transmission condition can be set beforehand, so that a facsimile transmission operation can be started as soon as the warm up is completed.

When the scan capability selection button 103 is selected, a scan operation is enabled as soon as the warm up for the scanner 16 is completed.

Also, when the box capability selection button 104 is selected, a manipulation is enabled before the warm up for printing by the printer 18 ends if one wishes to establish a box or he wishes to confirm the content of the box.

Further, when the login look-up capability selection button 106 or the machine setting capability selection button 107 is selected, a manipulation can be started at a time before a conventional warm up for the machine ends.

As has been described, according to the embodiment of the invention, a capability given with a high priority or the capability assigned to the selected capability selection button is enabled at a stage at which the minimum warm up ends according to such a capability. It is therefore possible to start a manipulation for such a capability at a time before a conventional warm up for the machine is completed.

Additional advantages and modifications will readily occur to those skilled in the art. Therefore, the invention in its broader aspects is not limited to the specific details and representative embodiments shown and described herein. Accordingly, various modifications may be made without departing from the sprit or scope of the general inventive concept as defined by the appended claims and their equivalents.

What is claimed is:

1. An image forming apparatus that is furnished with multiple capabilities and forms an image, comprising:
instruction means for giving an instruction, for the apparatus having two states including a normal state in which at least a normal operation is performed and a power saving state in which power consumption is less than in the normal state, to return to the normal state from the power saving state;
first control means for controlling a return operation needed for a pre-set capability given with a high priority when the power saving state is returned to the normal state according to the instruction from the instruction means; and
second control means for controlling the capability to be performed when the return operation ends under control of the first control means.

2. The image forming apparatus according to claim 1, further comprising:
selection means for selecting a desired capability during the return operation by the first control means; and
third control means for controlling a return operation needed for the capability selected by the selection means and thereby controlling the capability to be performed when the return operation for the capability ends.

3. The image forming apparatus according to claim 1, comprising:
set means for setting previously the capability given with a high priority when the power saving state is returned to the normal state.

4. The image forming apparatus according to claim 2, wherein:
the selection means is able to select a capability to look up logins in past times.

5. The image forming apparatus according to claim 2, wherein:
the selection means is able to select a facsimile transmission capability.

6. An image forming apparatus that is furnished with multiple capabilities and forms an image, comprising:
instruction means for giving an instruction, for the apparatus having two states including a normal state in which at least a normal operation is performed and a power saving state in which power consumption is less than in the normal state, to return to the normal state from the power saving state;
first control means for controlling a return operation needed for a pre-set capability given with a high priority when the power saving state is returned to the normal state according to the instruction from the instruction means;
second control means for controlling the capability to be performed when the return operation ends under control of the first control means;
selection means for selecting a desired capability during the return operation by the first control means; and
third control means for controlling a return operation needed for the capability selected by the selection means and thereby controlling the capability to be performed when the return operation for the capability ends.

7. An image forming apparatus that is furnished with multiple capabilities and forms an image, comprising:
set means for setting one capability among plural capabilities each taking a different time until the capability comes in an enabled state by a warm up started when a power supply is switched ON; and
control means for controlling the capability set by the set means to be enabled when a minimum warm up to perform the set capability is completed.

8. The image forming apparatus according to claim 7, further comprising:
selection means for selecting a capability different from the capability set by the set means; and
second control means for controlling a minimum warm up to perform the capability selected by the selection means and thereby controlling the capability to be enabled when the warm up ends.

9. The image forming apparatus according to claim 8, wherein:
the selection means is able to select a scan capability and a facsimile transmission capability that use only a scanner provided to the image forming apparatus, and is able to select a copy capability, a print capability, and a facsimile reception capability that use a printer provided to the image forming apparatus.

10. The image forming apparatus according to claim 8, wherein:
the selection means is able to select a capability to look up logins in past times.

11. The image forming apparatus according to claim 8, wherein:
the selection means is able to select a facsimile transmission capability.

12. An image forming apparatus that is furnished with multiple capabilities and forms an image, comprising:
set means for setting one capability among plural capabilities each taking a different time until the capability comes in an enabled state by a warm up started when a power supply is switched ON;
first control means for controlling the capability set by the set means to be enabled when a minimum warm up to perform the set capability is completed;
selection means for selecting a capability different from the capability set by the set means; and
second control means for controlling a minimum warm up to perform the capability selected by the selection means and thereby controlling the capabilities to be enabled when the warm up ends.

13. An image forming method for forming an image for an apparatus furnished with multiple capabilities, comprising:
under circumstances that the apparatus has two states including a normal state in which at least a normal operation is performed and a power saving state in which power consumption is less than in the normal state, providing an instruction to return to the normal state from the power saving state;
controlling a return operation needed for a pre-set capability given with a high priority when the power saving state is returned to the normal state according to the instruction; and
controlling the capability to be performed when the return operation ends under control.

14. The image forming method according to claim 13, further comprising:
selecting a desired capability during the return operation under the control, and controlling a return operation needed for the selected capability and thereby controlling the capability to be performed when the return operation of the capability ends.

15. An image forming method for forming an image for an apparatus furnished with multiple capabilities, comprising:
under circumstances that the apparatus has two states including a normal state in which at least a normal operation is performed and a power saving state in which power consumption is less than in the normal state, providing an instruction to return to the normal state from the power saving state;
controlling a return operation needed for a pre-set capability given with a high priority when the power saving state is returned to the normal state according to the instruction;
controlling the capability to be performed when the return operation ends under control;
selecting a desired capability during the return operation under the control; and
controlling a return operation needed for the selected capability and thereby controlling the capability to be performed when the return operation of the capability ends.

16. An image forming method for forming an image for an apparatus furnished with multiple capabilities, comprising:
selecting one capability among plural capabilities each taking a different time until the capability comes in an enabled state by a warm up started when a power supply is switched ON;
controlling the set capability to be enabled when a minimum warm up to perform the set capability is completed;
selecting a capability different from the set capability; and
controlling a minimum warm up to perform the selected capability and thereby controlling the capability to be enabled when the warm up ends.
